(19) United States
(12) Patent Application Publication
(10) Pub. No.: US 2026/0328317 A1
(43) Pub. Date: Oct. 22, 2026

(54) Sealing Element for a Fitting for Establishing a Fluid-Tight Screw Connection for a Pipe with an External Thread

(71) Applicant: Viega Technology GmbH & Co. KG, Attendorn (DE)

(72) Inventors: Philipp Dasbach, Wilnsdorf (DE); David Lindemann, Gummersbach (DE)

(21) Appl. No.: 19/421,221

(22) Filed: Dec. 16, 2025

(30) Foreign Application Priority Data
Dec. 20, 2024 (DE) 10 2024 139 195.2

(51) Int. Cl. F16L 15/04

(52) U.S. Cl. CPC F16L 15/04

(57) ABSTRACT

A sealing element for a fitting for establishing a fluid-tight screw connection for a pipe having an external thread, including a sealing body, a distal end section relative to the arrangement in the fitting, a proximal end section relative to the arrangement in the fitting, a middle section arranged between the distal end section and the proximal end section, and an internal thread formed at least in sections on the inside. The internal thread preferably extends continuously over the distal end section, the middle section, and the proximal end section, wherein the outer contour of the middle section protrudes radially beyond the outer contour of the distal end section and beyond the outer contour of the proximal end section, and wherein the sealing body is of monolithic design.

### CROSS-REFERENCE TO RELATED APPLICATION

This application claims priority to German Patent Application No. 102024139195.2 filed Dec. 20, 2024, the disclosure of which is hereby incorporated by reference in its entirety.

### BACKGROUND OF THE INVENTION

### Field of the Invention

The invention relates to a sealing element for a fitting for establishing a fluid-tight screw connection for a pipe having an external thread.

The technical field relevant to the present invention is the on-site installation of piping systems, in which generally a piping system consisting of pipe sections and fittings is installed for conveying and guiding a fluid, i.e., a liquid or a gas. A fitting is generally understood to be a connector for a pipeline, and a fitting is most commonly used to connect two or more pipe sections. The fitting therefore preferably has two or more press sections, for example in the form of press sleeves. The most common fittings include straight connectors, direction changes in the form of pipe bends, reducers, branches such as T-pieces or crosses. However, a fitting is also understood to mean a pipe connection of a tap or another component. For example, thermometers or manometers as fittings have only one connection for a pipe section. Thus, the fitting of a tap has only one press section in order to connect a pipe section to the tap.

The piping systems described above are used in particular for transporting drinking or heating water, gas for operating a heating system, or industrial gases. In principle, any fluid medium may be transported in the pipelines.

### DESCRIPTION OF RELATED ART

Fittings are often designed as press connectors, in which the fitting and a pipe to be connected are joined by radial deformation. In certain applications, such as connections with predefined threads, fluid-tight screw connections are required as fittings in order to prevent the escape of liquids or gases from a closed system.

In the prior art, a connecting element is proposed whose external thread is coated with a polyamide layer. External threads with PTFE sealing are widespread in sanitary and heating installations. These connectors have a region with a metallic external thread and a region in which a PTFE ring is seated as a thread seal. This seal does not have a thread. During assembly, the counterpart cuts into the PTFE seal and thus seals on the internal thread. Other common means of sealing include hemp in combination with a thread sealing compound, PTFE tape, or other sealants for application.

Such thermoplastic sealing materials as polyamide have a number of disadvantages, in particular the known sealing materials do not have permanent elasticity. The known sealing materials therefore become brittle over time and gradually lose their sealing properties. Higher temperatures or even greater temperature fluctuations, which cause the sealing material to be alternately heated and cooled, further promote embrittlement of the sealing material and thus the occurrence of leaks.

In addition to the disadvantageous PTFE tapes, it is also known to apply sealing elements made of another plastic to the external thread or the internal thread. During the screwing together of the threaded elements, the plastic seal effects a sealing of the thread.

In the sealing of the aforementioned threaded press connectors, disadvantages also occur in the connection structure, which are caused by spring-back properties of the material of the connected components as well as by temperature jumps after pressing. These effects lead to the formation of gaps within the thread and sealing system, which cannot be reliably bridged by the plastic seal.

Since the plastic seal can neither compensate for the spring-back of the fitting nor movements in the connection, an elastomer seal could be used. The elastomer seal can indeed prevent the formation of gaps, but there is then a risk of damage to the sharp thread edges. The use of elastomer seals for sealing threaded connections is therefore not possible.

The prior art describes a variant in which several components are used for sealing a threaded press connector. Since the sealing body requires several properties in order to seal permanently on different substrates, these functions have been distributed among several components. The seal comprises a combination of a PTFE thread seal and an EPDM O-ring. The PTFE seal, due to its good sliding properties, enables easy screwing and is insensitive to damage from nicks or sharp edges in the thread. The EPDM O-ring serves as a spring element to compensate, on the one hand, for tolerance fluctuations after pressing and, on the other hand, for fluctuations during operation, such as thermal expansion. Both seals are in contact with each other within the threaded press connector and result in a stable seal.

A disadvantage of the described embodiment is the higher manufacturing costs and higher assembly costs in the two-part design with a PTFE sealing element with thread and an EPDM O-ring as a spring element.

The present invention is therefore based on the technical problem of providing a sealing element for a fitting for establishing a fluid-tight screw connection for a pipe having an external thread, in which the disadvantages known from the prior art do not occur or at least occur to a lesser extent.

### SUMMARY OF THE INVENTION

The above-stated object is achieved according to the invention by a sealing element for a fitting for establishing a fluid-tight screw connection for a pipe having an external thread, having a sealing body, having a distal end section relative to the arrangement in the fitting, having a proximal end section relative to the arrangement in the fitting, having a middle section arranged between the distal end section and the proximal end section, and having an internal thread formed at least in sections on the inside, preferably extending continuously over the distal end section, the middle section, and the proximal end section, wherein the outer contour of the middle section protrudes radially beyond the outer contour of the distal end section and beyond the outer contour of the proximal end section, and wherein the sealing body is of monolithic design.

The monolithic sealing element is used in a fitting for establishing a fluid-tight screw connection to seal, after pressing, the gap between a base body of the fitting and an external thread of a pipe to be connected.

In addition, the monolithic sealing element compensates, by means of a resilient and compressed middle section, for fluctuations between the base body and the thread, which may arise due to tolerances, vibration, or thermal expansion.

The function of the sealing element is ensured to be long-lasting in drinking water and heating pipe arrangements, in particular for at least 50 years. The seal is robust and insensitive to possible damage or sharp edges in the thread of the pipe to be connected. Use in gas applications is also possible.

The radially outwardly enlarged, in particular bead-shaped, middle section is the compression and spring region, which, within the limits of the predetermined geometry, holds in reserve as much material as possible in order to maintain the preload of the sealing element. The middle section is arranged radially outside the sealing region of the internally formed thread.

The distal end section and the proximal end section adjacent to the middle section are in contact with a medium and are thus directly exposed to an aging process. On the distal side, aging occurs due to contact with the ambient air, and on the proximal inner side due to the medium in the pipeline, i.e., usually drinking water, heating water, or other fluids. The distal end section and the proximal end section may also be regarded as a “sacrificial region” or “aging section,” which may age before the material in the sealing middle section is affected. In the case of rubber materials, aging is generally described” and defined by hardening.

Furthermore, the design as a monolithic sealing element also reduces assembly costs compared to multiple individual components.

Preferably, the outer contour of the middle section has an outwardly curved, preferably sectionally round shape. This shape allows, on the one hand, a large amount of material to be incorporated into the middle section and, on the other hand, enables the sealing element to be better adapted to the inner contour of the fitting by means of the outer contour.

Furthermore, the outer contour of the distal end section may protrude radially beyond the outer contour of the proximal end section. This outer contour has the advantage that the corresponding inner contour of the fitting at the distal end can have a larger diameter than in inner region, thereby facilitating the insertion of the threaded section into the fitting.

In addition, the outer contour of the distal end section and/or the outer contour of the proximal end section may be essentially cylindrical in shape. The corresponding sections of the fitting may then also be of cylindrical design, which offers manufacturing advantages.

The sealing body is of monolithic design and thus constitutes a one-piece element. However, the sealing body may be composed of one material or of different materials.

On the one hand, the sealing body may consist entirely of the same material, which simplifies the manufacture of the sealing body. Because when only one material is used, conventional manufacturing methods such as injection molding can be employed.

On the other hand, the sealing body may be of monolithic design from at least two different materials. Such a sealing body can be produced by means of a 2K or XK process. With a two-component process (2K) or a multi-component process (XK), the material properties of the materials used can be combined in one component. In contrast to the usual injection molding process, different materials are injected successively into the injection mold in this process. This procedure is also referred to as 2K injection molding.

When two materials are used for the sealing element, at least a part of the regions forming the internal thread on the inside is made of a material with a first modulus of elasticity. The middle section is made of a material with a second modulus of elasticity at least in the region in which the outer contour of the middle section protrudes radially beyond the outer contour of the distal end section and beyond the outer contour of the proximal end section. Here, the first modulus of elasticity is greater than the second modulus of elasticity.

Thus, the internally located thread is formed from a harder material than the externally located region of the middle section with a softer material. Despite the different material properties, the sealing body remains of monolithic design.

In a further embodiment using three materials, an inner region of the middle section is formed from a first material. An outer region of the middle section is formed from a second material, and the distal end section and the proximal end section are formed from a third material. The first material has a greater modulus of elasticity than the second material, and the third material has greater resistance to media contact than the second material.

The measurement variable for the resistance of elastomers is the compression set, which indicates how elastomers behave under prolonged, constant compression and subsequent relaxation. In principle, plastics can creep, which is disadvantageous for a seal, as this reduces the surface pressure acting on the sealing surface. In addition, plastics can age due to oxidative attack. The third material protects the two inner materials from oxygen ingress, and the compartmentalization of the materials also prevents creeping.

The sealing body can be made from numerous materials. Preferably, the sealing body consists at least partially of one of the following materials: polytetrafluoroethylene (PTFE), ethylene propylene diene rubber (EPDM), fluorinated rubber (FKM), hydrogenated acrylonitrile butadiene rubber (HNBR), high-density polyethylene (PE-HD), chlorobutyl rubber (CIIR), polyamide (PA), polyhydroxybutyric acid (PBH), polybutadiene (butadiene rubber, PBR), and polyether ether ketone (PEEK).

The monolithic sealing element is therefore preferably made of an elastomer. Manufacture from another plastic, such as a thermoplastic, is also conceivable. The selected material must not have excessively high strength and should, if it can be described by a modulus of elasticity, have a modulus of elasticity of less than 5500 Mpa, preferably less than 1500 Mpa.

The material or materials selected must generally be capable of achieving a surface pressure and maintaining it by means of resilient elastic properties, which is higher than the prevailing internal system pressure.

### BRIEF DESCRIPTION OF THE DRAWINGS

The invention will be explained below by way of exemplary embodiments with reference to the drawings. In the drawings

FIG. 1 shows a fitting for establishing a fluid-tight screw connection for a pipe having an external thread with a sealing element according to the invention,

FIG. 2 shows the sealing element depicted in FIG. 1 in a partial cross-section,

FIG. 3 shows the sealing element according to FIGS. 1 and 2 in an isometric view,

FIG. 4 shows a sealing element according to the invention consisting of two different materials,

FIG. 5 shows a further sealing element according to the invention consisting of two different materials, and

FIG. 6 shows a sealing element according to the invention consisting of three different materials.

FIG. 7 shows the fitting according to FIG. 1 with a screwed-in pipe end and with an attached pressing jaw in cross-section,

FIG. 8 shows the fitting according to FIG. 7 in a schematic cross-sectional view before pressing, and

FIG. 9 shows the fitting according to FIG. 8 after pressing.

### DESCRIPTION OF THE INVENTION

In the following description of the various exemplary embodiments according to the invention, components and elements having the same function and mode of operation are provided with the same reference numerals, even if the components and elements may differ in their dimensions or shape in the different embodiments.

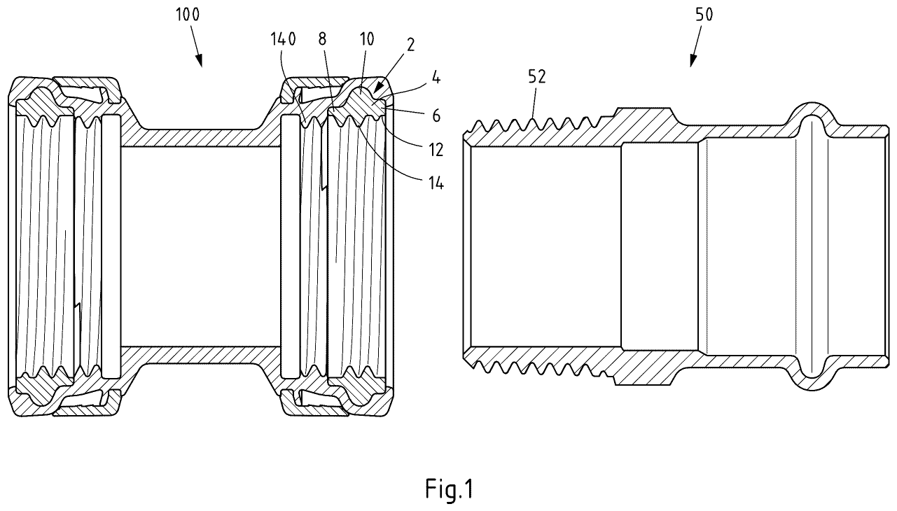

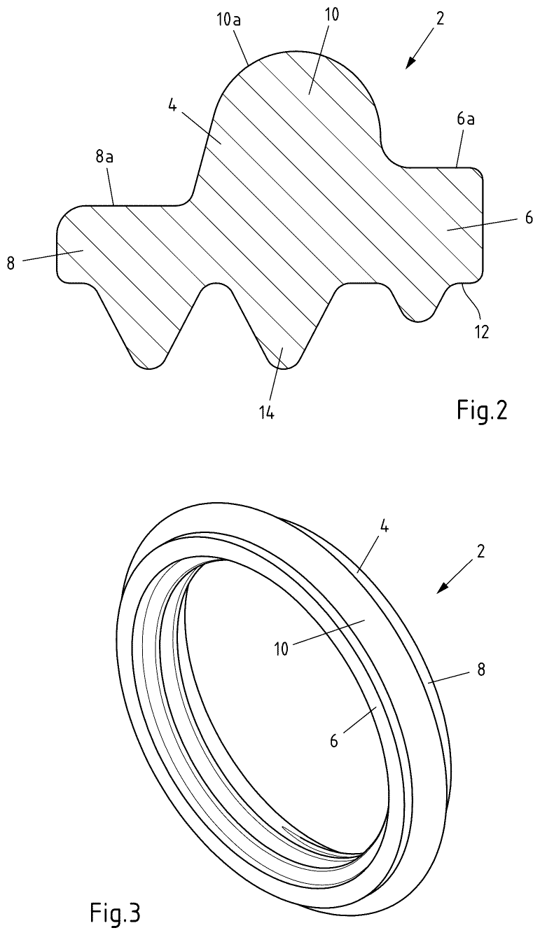

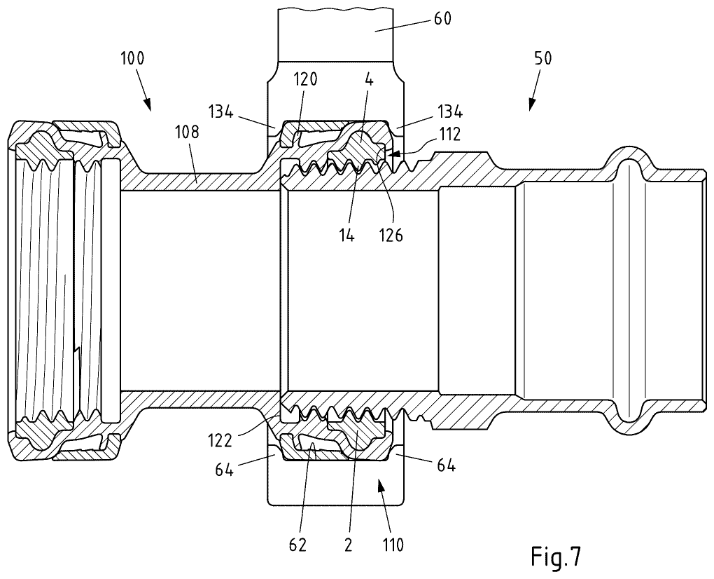

FIGS. 1 to 3 show a first sealing element 2 for a fitting 100 for establishing a fluid-tight screw connection for a pipe having an external thread. The fitting 100 is explained in more detail in connection with FIGS. 7 to 9.

The sealing element 2 comprises a sealing body 4 with a distal end section 6 relative to the arrangement in the fitting 100, a proximal end section 8 relative to the arrangement in the fitting, and a middle section 10 arranged between the distal end section 6 and the proximal end section 8.

On the inside 12 of the sealing body 4, an internal thread 14 is formed, which extends continuously over the distal end section 6, the middle section 10, and the proximal end section 8. The outer contour 10a of the middle section 10 protrudes radially beyond the outer contour 6a of the distal end section 6 and beyond the outer contour 8a of the proximal end section 8. In addition, the sealing body 4 is of monolithic design.

The sealing body 4 is thus geometrically designed so that the sealing element 2 has different regions that can fulfill the different functions. The bead-shaped middle section 10 so forms a compression and spring region, which stores as much material as possible in order to maintain the preload of the sealing element in a pressed connection between the fitting 100 and a pipe section 50 with a screwed-in threaded section 52. The middle section 10 is then arranged radially outside the sealing region of the formed internal thread 14.

The end sections 6 and 8 are arranged to the left and right of the bead-shaped middle section 10 in the figures and represent the regions which, in the pressed state of the fitting 100, are in contact with medium and are thus directly exposed to the aging process. On the distal side, aging occurs due to ambient air, and on the proximal side due to the medium in the pipeline, i.e., usually drinking water, heating water, or other fluids.

The end sections 6 and 8 can be regarded as a “sacrificial region” or “aging section,” which may age before the material of the middle section 10 in the sealing region beneath the middle section 10 is affected.

As further shown in FIGS. 1 to 3, the outer contour 10a of the middle section 10 has an outwardly curved and sectionally round shape. This forms the bead.

Furthermore, the outer contour 6a of the distal end section 6 protrudes radially beyond the outer contour 8a of the proximal end section 8. This allows the fitting 100 to have a larger opening at the distal end. In addition, the outer contours 6a and 8a of the distal end section 6 and the proximal end section 8 are essentially cylindrical in shape, although manufacturing-related deviations from the cylindrical shape may occur.

As shown, the sealing body 4 is of monolithic design from one material and is thus formed continuously homogeneous. The volume of the middle section 10, which is larger compared to the end sections 6 and 8, results in an increased overall elasticity at the same elasticity and enables the middle section 10 to maintain a permanent sealing function even in the event of fluctuations and/or vibrations, thereby maintaining the pressed secure state.

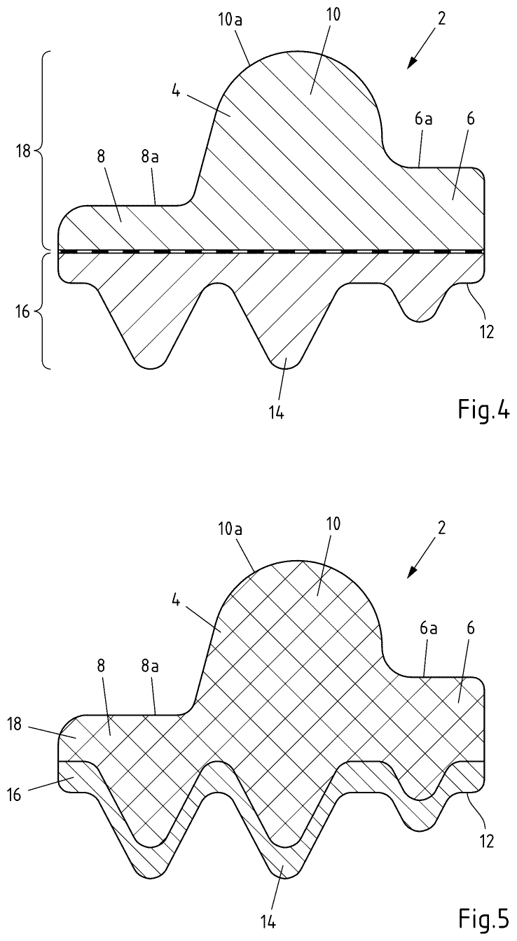

FIGS. 4 to 6 show exemplary embodiments in which the sealing body 4 is of monolithic design from at least two different materials.

FIG. 4 shows a sealing element 2 in which the regions forming the internal thread 14 of the end sections 6 and 8 and of the middle section 10 are formed on the inside from a material with a first modulus of elasticity. Furthermore, the middle section 10 is made of a material with a second modulus of elasticity. The selected materials allow the first modulus of elasticity to be greater than the second modulus of elasticity. Thus, the middle section 10 in its bead-shaped radial enlargement is more elastic than the internal thread 14.

In principle, it would therefor be sufficient for the middle section 10 at least in the region in which the outer contour 10a of the middle section 10 protrudes radially beyond the outer contour 6a of the distal end section 6 and beyond the outer contour 8a of the proximal end section 8.

FIGS. 4 and 5 show exemplary embodiments in which an inner region 16 of the end sections 6 and 8 as well as of the middle section 10 is formed from the first material, while the radially outwardly arranged region 18 of the end sections 6 and 8 as well as of the middle section 10 is formed from the second material. The different materials can be identified in FIGS. 4 and 5 by different hatching.

FIG. 4 shows the exemplary embodiment in which the boundary surface, shown in dashed lines, between the inner region 16 and the outer region 18 is formed as a cylindrical surface. FIG. 5, on the other hand, instead shows the exemplary embodiment in which the inner region 16 has a constant thickness in the axial direction and is formed similarly to an internally arranged coating.

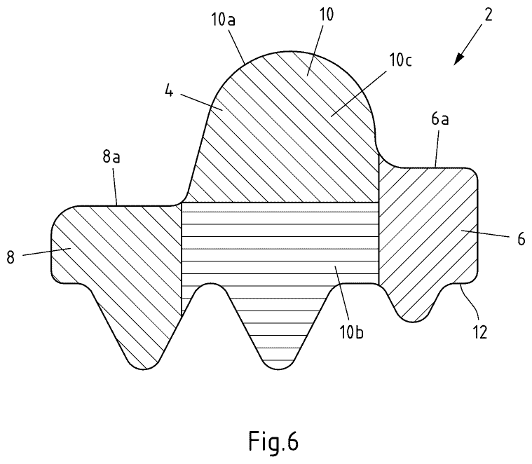

FIG. 6 shows an exemplary embodiment in which an inner region 10b of the middle section 10 is formed from a first material, an outer region 10c of the middle section 10 is formed from a second material, and the distal end section 6 and the proximal end section 8 are formed from a third material. The different materials can be identified in FIG. 6 by different hatching.

The first material here has a greater modulus of elasticity than the second material, and the third material has greater resistance to media contact than the second material. The measurement parameter for the resistance of elastomers is the compression set, which indicates how elastomers behave under prolonged, constant compression and subsequent relaxation. In principle, plastics can creep, which is disadvantageous for a seal, as this reduces the surface pressure acting on the sealing surface. In addition, plastics can age due to oxidative attack.

The sealing body 4 may consist at least partially of one of the following materials: polytetrafluoroethylene (PTFE), ethylene propylene diene rubber (EPDM), fluorinated rubber (FKM), hydrogenated acrylonitrile butadiene rubber (HNBR), high-density polyethylene (PE-HD), chlorobutyl rubber (CIIR), polyamide (PA), polyhydroxybutyric acid (PBH), polybutadiene (butadiene rubber, PBR), and polyether ether ketone (PEEK).

For some of these materials, the moduli of elasticity are given in the following:

| | | |
|---|---|---|
| PTFE | 200-800 | MPa |
| HDPE | 60-1350 | MPa |
| PA | 1000-3200 | MPa |
| PB | 400-700 | MPa |
| PE-HD | 650-950 | MPa |
| PEEK | 3000-3700 | MPa |
| EPDM | ~5 | MPa |

1 N/mm²=1 MPa

The structure and function of the fitting 100 will be explained in the following with reference to FIG. 1 and FIGS. 7 to 9. The figures show the fitting 100 for establishing a fluid-tight screw connection for a pipe 50 having an external thread 52. The pipe 50 may be part of another fitting, a connection stub on a container, or a connecting pipe to another fitting.

The fitting 100 comprises a fitting base body 108 and a press sleeve 110 connected to the fitting base body 108. The press sleeve 110 has a chamber 112 formed therein, in which a sealing element 2 according to FIGS. 1 to 3 is arranged.

FIG. 1 shows the fitting 2 separated from the pipe section 50, while FIG. 7 shows the fitting 100 screwed onto the pipe section 50.

As can be seen from the figures, a guide element 120 spaced from the chamber 112 and projecting radially outward is formed at the proximal end of the press sleeve 110 in the form of a separate part connected to the press sleeve 110. The guide element 120 essentially serves to allow a pressing jaw of a pressing tool to be positioned more easily and accurately.

The outer side of the press sleeve 110 has, at the distal end of the chamber 112, a diameter corresponding to the outer diameter of the projecting guide element 120. Overall, this results in an asymmetrical contour of the press sleeve 110.

Furthermore, a stop 122 for the sealing element 2 is formed on the inside of the proximal end of the press sleeve 110. Axially in the distal direction, an internal thread 140 is formed on the inside of the press sleeve 110, which is preferably aligned as uniformly as possible with the internal thread 14 of the sealing element 2. Furthermore, a stop 126 for the sealing element 2 is formed at the distal end of the press sleeve 110. This axially secures the sealing element 2.

FIG. 7 shows the fitting 2 with the screwed-in pipe 50 in the unpressed state and with an attached pressing jaw 60, which has an essentially cylindrical pressing contour 62. Only at two positions of the circumferential pressing contour 62 are radially inwardly projecting sections 64 formed, which engage with the press sleeve 110 in each case outside the chamber 112 and the guide element 120. The projecting sections 64, also referred to as guide cams, result in a lower pressing force than a circumferential guide rib, which would guide the fitting 2 during forming.

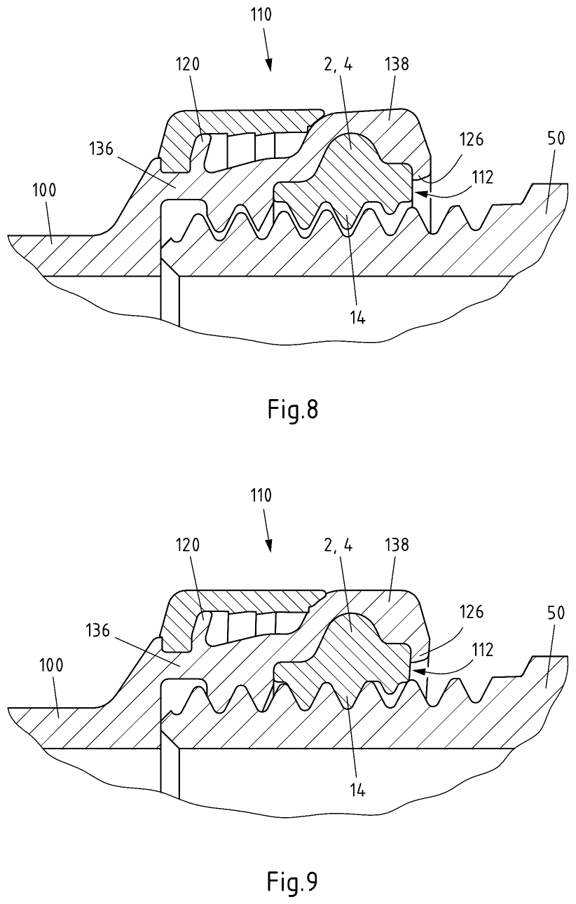

FIGS. 8 and 9 show the fitting 2 before and after pressing in a schematic representation.

The cylindrical pressing contour 62 deforms the press sleeve 110 during the radial inward pressing process, i.e., the distal end of the chamber 112 as well as the guide element 120, resulting primarily in a bending of the press sleeve 110 in the region of the two sections 136 and 138. This bending is also referred to as folding in the context of this description. Thus, the press sleeve 110 has a one-sided folding geometry. In addition, the guide element 120 bends inward.

By folding the press sleeve 110, on the one hand, the chamber 112, which is deformed radially inward, presses the sealing element 2 firmly onto the pipe 50 and the threaded section 52. This creates a section several thread turns long of the thread sections 14 and 52, along which the sealing element 2 is sealingly connected to the pipe 50.

Pressing forces and degree of deformation can be specifically adjusted by the one-sided folding geometry of the press sleeve 110. By reducing the size of the region of the press sleeve 110 to be deformed, the pressing forces are reduced and wall thicknesses can nevertheless be maintained.

The fitting 100 is made, for example, of silicon bronze, but may be made of any other metal or alloy. The fitting 100 is screwed onto an external thread according to DIN EN 10226 or ISO 228 and then pressed.

1. A sealing element for a fitting for establishing a fluid-tight screw connection for a pipe having an external thread,
with a sealing body,
with a distal end section relative to the arrangement in the fitting,
with a proximal end section relative to the arrangement in the fitting,
with a middle section arranged between the distal end section and the proximal end section, and
with an internal thread formed at least in sections on the inside, preferably extending continuously over the distal end section, the middle section and the proximal end section,
wherein the outer contour of the middle section protrudes radially beyond the outer contour of the distal end section and beyond the outer contour of the proximal end section, and
wherein the sealing body is of monolithic design.

2. The sealing element according to claim 1,
wherein
the outer contour of the middle section has an outwardly curved, preferably sectionally round shape.

3. The sealing element according to claim 1,
wherein
the outer contour of the distal end section protrudes radially beyond the outer contour of the proximal end section.

4. The sealing element according to claim 1,
wherein
the outer contour of the distal end section and/or the outer contour of the proximal end section are essentially cylindrical in shape.

5. The sealing element according to claim 1,
wherein
the sealing body consists monolithically of at least two different materials.

6. The sealing element according to claim 5,
wherein
at least a part of the regions forming the internal thread are formed on the inside from a material with a first modulus of elasticity,
the middle section is made of a material with a second modulus of elasticity at least in the region in which the outer contour of the middle section protrudes radially beyond the outer contour of the distal end section and beyond the outer contour of the proximal end section, and
in that the first modulus of elasticity is greater than the second modulus of elasticity.

7. The sealing element according to claim 5,
wherein
an inner region of the middle section is formed from a first material,
an outer region of the middle section is formed from a second material,
the distal end section and the proximal end section are formed from a third material,
the first material has a greater modulus of elasticity than the second material, and
the third material has greater resistance to media contact than the second material.

8. The sealing element according to claim 1,
wherein
the sealing body consists at least partially of one of the following materials: polytetrafluoroethylene (PTFE), ethylene propylene diene rubber (EPDM), fluorinated rubber (FKM), hydrogenated acrylonitrile butadiene rubber (HNBR), high-density polyethylene (PE-HD), chlorobutyl rubber (CIIR), polyamide (PA), polyhydroxybutyric acid (PBH), polybutadiene (butadiene rubber, PBR) and polyether ether ketone (PEEK).
